(19) United States
(12) Patent Application Publication
(10) Pub. No.: US 2002/0185622 A1
(43) Pub. Date: Dec. 12, 2002

(54) Gasoline pump clip

(76) Inventor: Rusty E. Bruns, Charleston, SC (US)

Correspondence Address: MICHAEL A MANN, NEXSEN PRUET JACOBS & POLLARD LLC, PO DRAWER 2426, COLUMBIA, SC, 29202-2426, US

(21) Appl. No.: 09/876,517

(22) Filed: Jun. 7, 2001

(51) Int. Cl. F16K 35/00

(52) U.S. Cl. 251/90; 251/111; 141/391; 141/392

(57) ABSTRACT

A gasoline pump clip holds the operating lever of the pump nozzle in the “on” position. The nozzle is generally “C” shaped so that it can be used from either side or upside down. One portion of the “C” is inserted into the handle frame to hold the operating lever in its on position while the other portion of the “C” rests on top of the handle frame, thus holding the operating lever to the top of the frame. The “C” shape also guards against rotation of the clip from its working position and makes it compact enough to be secured to the inside of the vehicle's fill port cover.

### FIELD OF THE INVENTION

The present invention relates generally to the operation of a gasoline pump at a service station. En particular, it relates to devices for holding the operating lever in the “on” position.

### BACKGROUND OF THE INVENTION

At gasoline service stations, gasoline maybe pumped into the gasoline tanks of vehicles from underground gasoline tanks using pumps. The pumps have nozzles that are insertable into the fill port of the vehicle. By squeezing the operating lever of the valve in the nozzle handle, gasoline is released into the vehicle's gasoline tank. This process of refilling a gasoline tank is a simple one and other than being a minor nuisance when traveling, is not normally a difficult task.

It takes a few minutes for most tanks to fill; it takes much longer for larger tanks, such as those on tractors and other large trucks or boats at dockside service stations and when at slower-filling pumps. Hands tend to tire when holding the operating lever for longer periods of time. In bitter cold weather, squeezing the operating handle even for a minute or two can be very disagreeable. For the elderly and others of limited strength, squeezing the handle can be very difficult in any weather. Finally, some individuals have illnesses or diseases, such as anemia or neuropathy, that make it difficult or impossible to squeeze the operating lever for more than a short period of time without their hands becoming painfully numb, regardless of hand strength.

In addition to the problem of physically holding the operating lever in the “on” position, there is the lost time involved, time that could be spent washing the windshield, checking oil or tire pressure, or otherwise engaged in activities the driver wishes to be engaged in.

Pump nozzles are all equipped with an automatic shut off mechanism that senses when the tank is full and responds by switching the nozzle valve to a closed or “off” position. Someone operating the operating lever by squeezing it so that the nozzle lever is in the on position will find that the pump shuts off when the tank is filled regardless of whether the lever is still being squeezed.

There have been a number of improvements made in automatic shutoff valves for gasoline pump nozzles. However, there have been few improvements that it easier and quicker to fill the gasoline tank. Furthermore, many pump handles previously came equipped with a clip that held the operating lever in the on position but which clip has subsequently been removed or disabled.

Thus there remains a need for way to keep the operating lever of a gasoline pump handle in the “on” position until the automatic cut off switch shuts off the pump or the user decides to shut off the pump.

### SUMMARY OF THE INVENTION

According to it major aspects and briefly recited, the present invention is a clip for use in holding the operating lever of a gasoline pump nozzle in the “on” position. The clip is preferably in a “C” shape. The lower portion of the “C” is insertable into the handle frame of the pump once the operating lever is lifted to the “on” position, that is, toward the upper part of the handle frame. The upper portion of the “C” rests over the top of the handle frame so that the top of the handle frame and thus the operating lever is between the top and the bottom portions of the clip. The operating lever is biased downward by a spring against the lower portion of the clip. Thus, when in position, the clip simulates the operator's hand, squeezing the operating lever toward the top of the handle frame against its spring bias and will not interfere with a properly functioning automatic shutoff valve. Some of the clip dimensions are critical and allow it to hold the lever in the correct position; moreover, the “C” shape, while not critical, is nonetheless strongly preferred for several reasons. First, it is symmetric top to bottom and thus allows the device to be used right side up or upside down. Because the pump handle is symmetric left to right, the “C” shaped clip can also be inserted from either side of the pump nozzle handle. Second, having the top portion of the clip rest on the top of the handle frame holds the clip upright and thus stabilizes the lower portion of the clip against rotation, which might otherwise release the operating lever. Third, the device is compact, which allows it to be stored where it cannot easily be lost or forgotten, such as, preferably, on the inside of the gasoline fill port cover.

Preferably, the clip carries means for attaching it to the fill port cover. Magnets or hook and loop fasteners such as those sold under the trademark VELCRO are preferred for this function.

Other features and their advantages will become apparent to those skilled in the art of automobile pump design from a careful reading of the following Detailed Description of Preferred Embodiments, accompanied by the drawings

### BRIEF DESCRIPTION OF THE DRAWINGS

In the drawings,

FIG. 1 is a perspective view of a gasoline pump nozzle with the present clip inserted in the nozzle's frame, according to a preferred embodiment of the present invention;

FIG. 2 is a perspective view of a clip stored on the cover of the vehicle's gasoline fill port, according to a preferred embodiment of the present invention; and

FIG. 3 is a side view of a clip according to a preferred embodiment of the present invention.

### DETAILED DESCRIPTION OF PREFERRED EMBODIMENTS

The present invention is a clip for use in holding the operating lever of a gasoline pump in the on position in which position the pump will dispense gasoline.

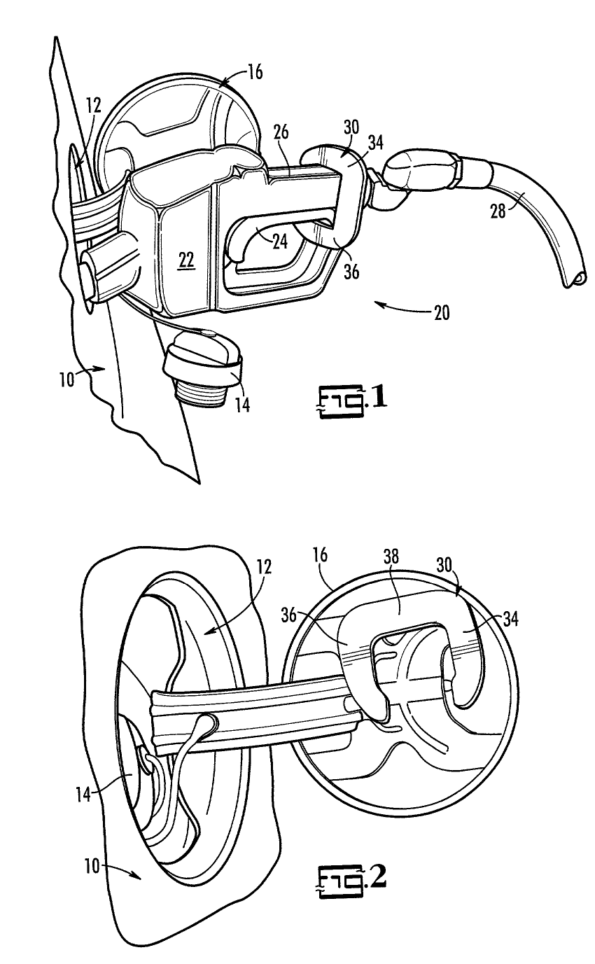

Referring now to the figures, FIG. 1 illustrates in perspective a pump nozzle that has a clip according to a preferred embodiment of the present invention being used to hold the operating lever of the pump nozzle in the “on” position. In particular, a vehicle 10 has a fill port 12 with threaded cap 14 and a cover 16. To dispense gasoline into the tank (not shown) of vehicle 10, cover 16 is rotated to an opened position as shown, cap 14 is removed, and a pump nozzle 20 connected to a source of gasoline (not shown) is inserted into fill port 12.

Pump nozzle 20 has a valve 22 controlled by an operating lever 24 carried within a handle frame 26. Nozzle 20 is connected to a hose 28 that leads to the gasoline source.

Operating lever 24 is biased downward by a spring (not shown) so that it is normally in an “off” or down position. When lifted as shown in FIG. 1, operating lever 24 will open valve 22 to release gasoline into the tank of vehicle 10. Operating lever 24 must be held in an up or “on” position against the bias of the spring until the desired amount of gasoline is dispensed. The operating lever 24 is released to the “off” or down position to cut off the flow of gasoline through valve 22. If the tank fills before lever 24 is released, however, valve 22 will shut off automatically to prevent gasoline from spilling. Vehicle 10, pump nozzle 20, gasoline source and gasoline are not part of the present invention, which is a clip 30. Clip 30 is intended to be used with and to cooperate with pump nozzle 20.

Once operating lever 24 is raised, clip 30 can be used to maintain the flow of gasoline through valve 22 without the user holding operating lever 24 in the “on” position. Clip 30 holds lever 24 in the “on” position until it is removed by the user or the tank of vehicle 10 fills and pump nozzle 20 is shut off by its own automatic shutoff mechanism.

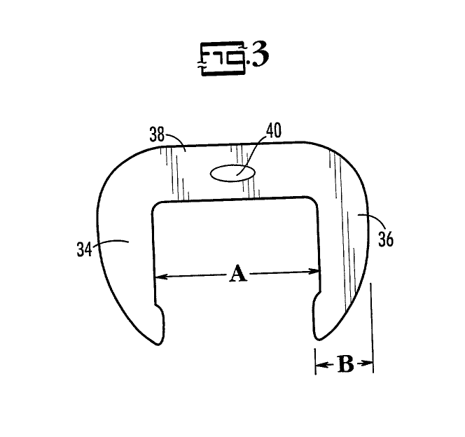

Clip 30, as best seen in FIGS. 2 and 3, is generally “C” shaped. It has an upper portion 34 and a lower portion 36 joined by a spine 38. Lower portion 36 is insertable into handle frame 26 after lever 24 is raised. Upper portion is placed over the top of handle frame 26. Thus positioned, the downward pressure of spring-biased operating lever 24 against lower portion 36 and the stationary top of handle frame 26 are held squeezed together by upper portion 34 and lower portion 36 in the same manner as a human hand would do when in the act of pumping gasoline.

It will be clear that the interior width, that is, the distance between the two nearest parts of upper and lower portions 34, 36, indicated in FIG. 3 by the letter A, and the width of lower portion 36, indicated by the letter “B” in FIG. 3, are critical. The distance A determines the extent to which operating lever 24 is squeezed and thus how “open” valve 22 is. This distance must be at least the width of handle frame 26 plus that of operating lever 24 when in the “on” position, but must be less than what would fit around lever 24 and handle frame 26 when lever 24 is in the “off” position.

The width B must be small enough to fit between the bottom of handle frame 26 and operating lever 24.

By way of example, clip 30 can be one half inch thick, 3 ⅞ inch long and 2 13/16th inches high. The distance designated A in FIG. 3 can then be 1 ⅞ inches but closing by about 1/4 inches at the mouth of the “C”, and the distance designated B can then be ¾ inches wide.

Preferably clip 30 is symmetric top to bottom so that the width B of lower portion 36 is the same as the width of upper portion so that it can be used right side up as well as upside down. Because pump nozzle 20 is symmetric left to right, clip 30 can also be inserted from either side. Preferably also clip 30 is made of a material, and its width and thickness is sufficient in that material, to hold lever 24 against the spring bias. Also, preferably clip 30 is made of a material that does not absorb gasoline vapors and is not prone to spark, such as many different types of plastics, aluminum and wood.

Finally, clip 30 preferably has slightly expanded widths on upper and lower portions 34, 36, so that the distance separating upper and lower portions 34, 36, respectfully, near their ends is smaller to help prevent the inadvertent lateral removal of clip 30.

Clip 30 is also preferably kept small so as to be compact and easily storable. Clip 30 can be made small enough to be stored conveniently on the inside of cover 16. Cover 16 can be formed to receive clip 30 such as by having a small pocket in which clip 30 can be inserted or a retainer to hold clip 30. Alternatively, clip 30 can carry a magnet 40 attached or embedded in it that will be attracted and held to a metal cover 16. Alternatively, in place of magnet 40, hook and loop fasteners such as those sold under the trademark VELCRO can be used. In this case, the first portion of a hook and loop fastener would be adhered to the inside of cover 16 and the second portion adhered to clip 30.

In use, the user squeezes operating lever 24 to the “on” position and inserts clip 30 into the handle frame. The user may then release lever 24 and rely on clip 30 to hold it in the “on” position until the tank of vehicle 10 is full or the desired amount of gasoline has been dispensed. At that time, clip 30 is removed.

It will be clear that service stations can tether a clip to each pump handle perhaps using a short length of chain, rope or flexible plastic wire. Also, the present clip is not so large that some might prefer to use it as a device on a key chain.

It will be clear to those skilled in gasoline pump design that many substitutions and modifications can be made to the foregoing preferred embodiments without departing from the spirit and scope of the present invention, defined by the appended claims.

What is claimed is:

1. A device for use with a gasoline pump nozzle, said pump nozzle having a handle frame with a top and an opposing bottom and an operating lever, said operating lever having an on position and an off position, said device comprising:
a first portion dimensioned to be receivable by said pump nozzle between said bottom of said handle frame and said operating lever when said operating lever is in said on position;
a second portion in engagement with said handle frame when said first portion is received by said pump nozzle, said second portion stabilizing said first portion against rotation; and
means for connecting said first and said second portions together.

2. The device as recited in claim 1, wherein said second portion engages said handle frame so that said operating lever and said handle frame are between said first and said second portions.

3. The device as recited in claim 1, wherein said first portion has a width and said second portion has a width, and wherein said widths of said first and said second portions are the same.

4. The device as recited in claim 1, wherein said device is made of a material that does not absorb gasoline vapors.

5. The device as recited in claim 1, wherein said device is made of a material selected from the group consisting of wood, plastic and aluminum.

6. The device as recited in claim 1, further comprising means for removably attaching said device to a surface.

7. The device as recited in claim 6, wherein said attaching means is selected from the group consisting of magnets and hook and loop fasteners.

8. A device for use with a gasoline pump nozzle, said pump nozzle having a handle frame with a top and an opposing bottom and an operating lever, said operating lever having an on position and an off position, said device comprising:
a first portion dimensioned to be receivable by said pump nozzle between said bottom of said handle frame and said operating lever when said operating lever is in said on position;
a second portion engaging said handle frame when said first portion in received by said pump nozzle; and
a spine connecting said first and said second portions together so that said first portion, said second portion and said spine for a “C” shape.

9. The device as recited in claim 8, further comprising a magnet carried by said device.

10. The device as recited in claim 9, wherein said magnet is embedded in said device.

11. The device as recited in claim 8, further comprising means for attaching said device to a surface.

12. The device as recited in claim 11, wherein said attaching means further comprises a hook and loop fastener.

13. The device as recited in claim 8, wherein said device is dimensioned to be carried by a gasoline tank fill port cover.

14. A device for use with a gasoline pump nozzle, said pump nozzle having a handle frame having a top and an opposing bottom and an operating lever, said operating lever having an on position and an off position, said device comprising a removable clip adapted and dimensioned to hold said operating lever against said top of said handle frame, said operating lever being held in said on position when said clip is holding installed on said pump nozzle.

15. The device as recited in claim 14, wherein said clip is symmetrical so that said clip can be used right side up and upside down.
